(19) United States
(12) Patent Application Publication
(10) Pub. No.: US 2011/0106510 A1
(43) Pub. Date: May 5, 2011

(54) METHODS, APPARATUS AND COMPUTER READABLE STORAGE MEDIUMS FOR MODEL-BASED DIAGNOSIS

(76) Inventor: Siu Yun Poon, Nottinghamshire (GB)

(21) Appl. No.: 12/736,582

(22) PCT Filed: Apr. 29, 2009
(86) PCT No.: PCT/EP2009/055237

§ 371 Date: Dec. 3, 2010

(30) Foreign Application Priority Data
Apr. 29, 2008 (GB) 0807775.2

(51) Int. Cl. G06F 17/10; G05B 23/02

(52) U.S. Cl. 703/2

(57) ABSTRACT

The invention relates to the diagnosis of faults and damage in a gearbox in order to predict the operational life of a gearbox. An end of line test is performed to infer information on each gearbox on the production line. A highly detailed model of the gearbox is created to determine the optimal sensor positions for the end-of-line test so that the test can discriminate between different types of manufacturing variation. This information is then used to construct a unique, highly detailed model for each gearbox. During operation, forces and moments acting on the gearbox are measured at regular intervals and the model is used to continuously update a prediction of the total damage on each gearbox component. The probability of failure in a given time period is then calculated. An existing condition monitoring system approach such as vibration analysis may be used in parallel with the model-based diagnosis. The overall probability of failure for a required lifetime is calculated and, if necessary, operation is limited to provide a required probability of failure in a given time period.

Embodiments of the invention relate to gearbox fault diagnosis and condition monitoring systems for gearboxes.

In-service failure of gearboxes is common and can be very costly. Continuous monitoring of the condition of a gearbox can lead to impending failures being identified. This allows users or operators to be alerted so that they can take remedial action before a costly or catastrophic failure occurs.

One example of a gearbox which can benefit from in-service condition monitoring is a gearbox in a wind turbine. In operation, wind turbines are subject to loads which act on the structure and the rotor blades. These loads can act in any direction and can act asymmetrically on the wind turbine. The resulting loads acting on the rotor blade hub may be forces acting in any direction and moments about any axis. These forces and moments cause deflections within the gearbox affecting the amount of damage caused to individual gearbox components.

The problem is further complicated by the fact that the loads acting on the wind turbine are stochastic in nature and therefore difficult to predict.

Machine operators (such as wind turbine operators) must choose the most appropriate maintenance regime for a system. Typically these may include run-to-failure, scheduled maintenance and/or condition based (reliability centred) maintenance. Condition monitoring is an established practice in engineering, and is an important element of a condition based maintenance regime. It is widely regarded that condition based maintenance may be employed when a machine satisfies one or more of the following conditions:
The machine is expensive;
There is a long lead time for spares;
Interruptions in operation are costly;
Overhaul is expensive and requires highly trained people;
Reduced numbers of skilled maintenance people are available;
The costs of a monitoring programme are acceptable;
Failures may be dangerous;
The equipment is remote;
Failures are not indicated by degeneration of normal operational outputs; and/or
Secondary damage may be costly.

Wind turbines may satisfy many of these conditions so are well suited to condition based maintenance. However, wind turbine operators are generally unable to employ a condition based maintenance strategy because they are unable to accurately predict or measure the condition of a wind turbine at any point in time.

Existing approaches to condition monitoring include: vibration analysis; acoustic monitoring; analysis of oil quality; temperature monitoring; and electrical generator monitoring. A disadvantage of these approaches is that there is no existing method for relating the measured/monitored quantities with the remaining life of individual components in a gearbox. Similarly, the approaches cannot relate the measured quantities with probability of failure in a given time period. Existing condition monitoring systems all have this shortcoming.

Wind turbine operators wish to know the probability of failure in the time period up to the next scheduled maintenance. The cost of arranging unscheduled maintenance of a wind turbine is very high, especially if the wind turbine is off-shore.

Vibration analysis is currently widely used in gearbox condition monitoring. However, existing vibration analysis methods generally rely on placing a sensor close to each component to be monitored. For example, a sensor may be placed close to an epicyclic gear set in the gearbox. Sensors are positioned in this way in order to maximise the signal-to-noise ratio. However, this does not necessarily optimise the conveyance of the maximum information about a given gearbox design. Sensors should be placed in order to give good fault isolability. However, no formalised, practical solution has been proposed, mainly due to the lack of sufficiently detailed models.

As used herein the term “fault isolability” encompasses the ability to isolate particular faults within a system when data is recorded using a sensor or combination of sensors. Sensors may be placed at locations around a system such that a single sensor output or multiple sensor outputs allow isolation of system faults.

In existing vibration analysis approaches, the user is alerted that there may be a fault or manufacturing error somewhere in a component if the measurement provided by a sensor exceeds a predetermined threshold. However, no information is provided as to the exact nature of the fault or error. This method is also highly prone to false-alarms. Firstly, there is no discrimination between vibrations associated with failure or damage and those which are not indicative of failure or damage. Secondly, the choice of threshold level is critical to the ability of a vibration analysis system to reliably detect failure or damage. The threshold level is not necessarily constant and may vary with frequency (and hence speed). The presence of shocks and extraneous vibrations means that the threshold level must be set sufficiently high to minimise the risk of false-alarms. Furthermore, the threshold must be sufficiently high to avoid any negative effects caused by ‘creep’ in sensor performance which may occur over its lifetime.

Consequently, vibration analysis is not only highly prone to false-alarms, but can also fail to detect critical damage or failures if the corresponding vibrations lie below the threshold level. It is generally very difficult or impossible for a gearbox operator to interpret whether an alarm generated by an existing vibration analysis condition monitoring system (CMS) is real or false.

Gearbox maintenance on off-shore wind turbines is very difficult due to the installation environment and must be carefully scheduled. Unscheduled maintenance is very expensive. If a gearbox fails, the wind turbine owner or operator must consider the very high costs associated with an unscheduled maintenance and weigh these against the loss in earnings due to lack of power generation if they wait until the next scheduled maintenance. They must also consider subsidiary effects such as corrosion and bearing damage that may occur if the gearbox components are not regularly rotated.

If a condition monitoring system triggers an alarm then the wind turbine operator must consider the probability that this alarm is false. If an alarm indicates that some damage has occurred, the operator may wish to decrease the probability that a costly failure will occur before the next scheduled maintenance by operating the turbine at a lower energy-producing capacity. This may be achieved by changing the pitch on the rotor blades or by shutting down the wind turbine under certain conditions. However, existing CMSs are unable to provide information on the probability of component failure within a gearbox. There is a strong need for this information yet existing condition monitoring approaches are unable to provide it.

Existing CMSs generally deal with diagnosis of faults. However, for gearbox operators wishing to operate in a condition based maintenance regime, prognosis of the condition of the machine is highly desirable. This is particularly the case in the field of wind turbine gearboxes, for which no such solution exists.

It would be desirable to mitigate or overcome at least some of the problems in the prior art highlighted above.

According to an aspect of the invention there is provided a method for determining end-of-line test sensor positions in or on a gearbox, drive-train and/or generator, the method comprising: a) generating a nominal model for a gearbox, drive-train and/or generator and calculating a first set of simulated responses corresponding to one or more locations in or on a modelled gearbox, drive-train and/or generator; b) introducing manufacturing variations into the nominal model and calculating a second set of simulated responses corresponding to the one or more locations in or on the modelled gearbox, drive-train and/or generator; c) generating an array of simulated residuals based on differences between the first and second sets of simulated responses; and d) selecting one or more of the one or more locations in or on the modelled gearbox, drive-train and/or generator as location sites for end-of-line test sensors based on the values of the simulated residuals corresponding to each of the one or more locations.

According to another aspect of the invention there is provided an apparatus for determining end-of-line test sensor positions in or on a gearbox, drive-train and/or generator, the apparatus comprising: means for generating a nominal model for a gearbox, drive-train and/or generator and calculating a first set of simulated responses corresponding to one or more locations in or on a modelled gearbox, drive-train and/or generator; means for introducing manufacturing variations into the nominal model and calculating a second set of simulated responses corresponding to the one or more locations in or on the modelled gearbox, drive-train and/or generator; means for generating an array of simulated residuals based on differences between the first and second sets of simulated responses; and means for selecting one or more of the one or more locations in or on the modelled gearbox, drive-train and/or generator as location sites for end-of-line test sensors based on the values of the simulated residuals corresponding to each of the one or more locations.

According to another aspect of the invention there is provided a computer readable storage medium encoded with instructions that, when executed by a processor, perform: a) generating a nominal model for a gearbox, drive-train and/or generator and calculating a first set of simulated responses corresponding to one or more locations in or on a modelled gearbox, drive-train and/or generator; b) introducing manufacturing variations into the nominal model and calculating a second set of simulated responses corresponding to the one or more locations in or on the modelled gearbox, drive-train and/or generator; c) generating an array of simulated residuals based on differences between the first and second sets of simulated responses; and d) selecting one or more of the one or more locations in or on the modelled gearbox, drive-train and/or generator as location sites for end-of-line test sensors based on the values of the simulated residuals corresponding to each of the one or more locations.

According to another aspect of the invention there is provided a method for determining actual manufacturing variations of one or more components of a gearbox, drive-train and/or generator, the method comprising: a) providing simulated responses of a nominal model of a gearbox, drive-train and/or generator; b) providing an array of simulated residuals corresponding to one or more locations in or on a modelled gearbox, drive-train and/or generator; c) placing one or more end-of-line test sensors at one or more locations in or on a gearbox, drive-train and/or generator, wherein the one or more locations in or on the gearbox, drive-train and/or generator correspond to the one or more locations in or on the modelled gearbox, drive-train and/or generator; d) running the gearbox, drive-train and/or generator; e) detecting and recording responses at the one or more locations in or on the gearbox, drive-train and/or generator using the one or more end-of-line test sensors; f) calculating recorded residuals based on the recorded responses and the simulated responses; and g) determining the actual manufacturing variations of the components of the gearbox, drive-train and/or generator by comparing the recorded residuals to the simulated residuals.

According to another aspect of the invention there is provided an apparatus for determining actual manufacturing variations of one or more components of a gearbox, drive-train and/or generator, the apparatus comprising: means for providing simulated responses of a nominal model of a gearbox, drive-train and/or generator; means for providing an array of simulated residuals corresponding to one or more locations in or on a modelled gearbox, drive-train and/or generator; means for placing one or more end-of-line test sensors at one or more locations in or on a gearbox, drive-train and/or generator, wherein the one or more locations in or on the gearbox, drive-train and/or generator correspond to the one or more locations in or on the modelled gearbox, drive-train and/or generator; means for running the gearbox, drive-train and/or generator; means for detecting and recording responses at the one or more locations in or on the gearbox, drive-train and/or generator using the one or more end-of-line test sensors; means for calculating recorded residuals based on the recorded responses and the simulated responses; and means for determining the actual manufacturing variations of the components of the gearbox, drive-train and/or generator by comparing the recorded residuals to the simulated residuals.

According to another aspect of the invention there is provided a computer readable storage medium encoded with instruction that, when executed by a processor, perform: a) providing simulated responses of a nominal model of a gearbox, drive-train and/or generator; b) providing an array of simulated residuals corresponding to one or more locations in or on a modelled gearbox, drive-train and/or generator; c) calculating recorded residuals based on recorded responses and the simulated responses, the recorded responses being detected and recorded, while the gearbox, drive-train and/or generator is/are run, at one or more locations in or on the gear box, drive train, and/or generator by one or more end of line test sensors, the one or more locations in or on the gear box, drive train and/or generator corresponding to the one or more locations in or on the modelled gearbox, drive-train and/or generator; and d) determining the actual manufacturing variations of the components of the gearbox, drive-train and/or generator by comparing the recorded residuals to the simulated residuals.

According to another aspect of the invention there is provided a method for operating a gearbox, drive-train and/or generator, the method comprising a) monitoring over time forces and moments acting on the gearbox, drive-train and/or generator; b) calculating damage caused to each of the one or more components of the gearbox, drive-train and/or generator based on the forces and moments acting on the gearbox, drive-train and/or generator; c) predicting the life of the one or more components within the gearbox, drive-train and/or generator based on the calculated damage to the one or more components and predetermined or predicted future operating conditions of the gearbox, drive-train and/or generator.

According to another aspect of the invention there is provided an apparatus for operating a gearbox, drive-train and/or generator, the apparatus comprising means for monitoring over time forces and moments acting on the gearbox, drive-train and/or generator; means for calculating damage caused to each of the one or more components of the gearbox, drive-train and/or generator based on the forces and moments acting on the gearbox, drive-train and/or generator; means for predicting the life of the one or more components within the gearbox, drive-train and/or generator based on the calculated damage to the one or more components and predetermined or predicted future operating conditions of the gearbox, drive-train and/or generator.

According to another aspect of the invention there is provided a computer readable storage medium encoded with instructions that, when executed by a processor, perform: calculating damage caused to each of the one or more components of the gearbox, drive-train and/or generator based on monitored forces and moments acting on the gearbox, drive-train and/or generator; predicting the life of the one or more components within the gearbox, drive-train and/or generator based on the calculated damage to the one or more components and predetermined or predicted future operating conditions of the gearbox, drive-train and/or generator.

According to another aspect of the invention there is provided a method for operating a gearbox, drive-train and/or generator, the method comprising: a) monitoring over time one or more forces and/or one or more moments acting on the gearbox, drive-train and/or generator; b) calculating damage caused to each of the one or more components of the gearbox, drive-train and/or generator based on the one or more forces and/or one or more moments acting on the gearbox, drive-train and/or generator; c) predicting the life of the one or more components within the gearbox, drive-train and/or generator based on the calculated damage to the one or more components and predetermined or predicted future operating conditions of the gearbox, drive-train and/or generator.

According to another aspect of the invention there is provided an apparatus for operating a gearbox, drive-train and/or generator, the apparatus comprising: means for monitoring over time one or more forces and/or one or more moments acting on the gearbox, drive-train and/or generator; means for calculating damage caused to each of the one or more components of the gearbox, drive-train and/or generator based on the one or more forces and/or one or more moments acting on the gearbox, drive-train and/or generator; means for predicting the life of the one or more components within the gearbox, drive-train and/or generator based on the calculated damage to the one or more components and predetermined or predicted future operating conditions of the gearbox, drive-train and/or generator.

According to another aspect of the invention there is provided a computer readable storage medium encoded with instructions that, when executed by a processor, perform: a) monitoring over time one or more forces and/or one or more moments acting on the gearbox, drive-train and/or generator; b) calculating damage caused to each of the one or more components of the gearbox, drive-train and/or generator based on the one or more forces and/or one or more moments acting on the gearbox, drive-train and/or generator; c) predicting the life of the one or more components within the gearbox, drive-train and/or generator based on the calculated damage to the one or more components and predetermined or predicted future operating conditions of the gearbox, drive-train and/or generator.

There now follows a description of embodiments of the invention, by way of non-limiting examples, with reference being made to the accompanying drawings in which:

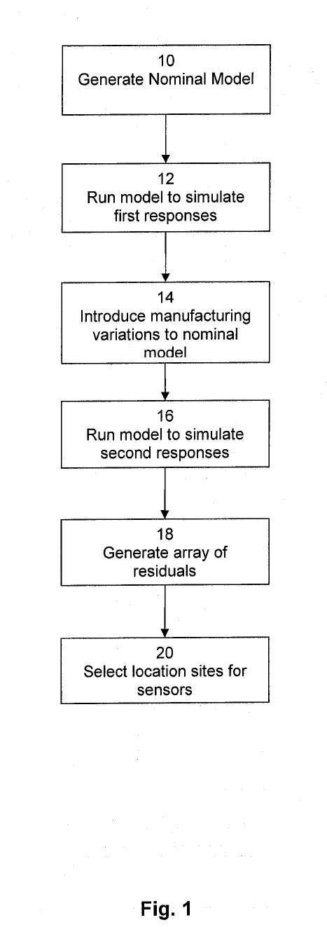

FIG. 1 shows a flow chart identifying the steps associated with determining end-of-line test sensors positions in or on a gearbox, drive-train or generator;

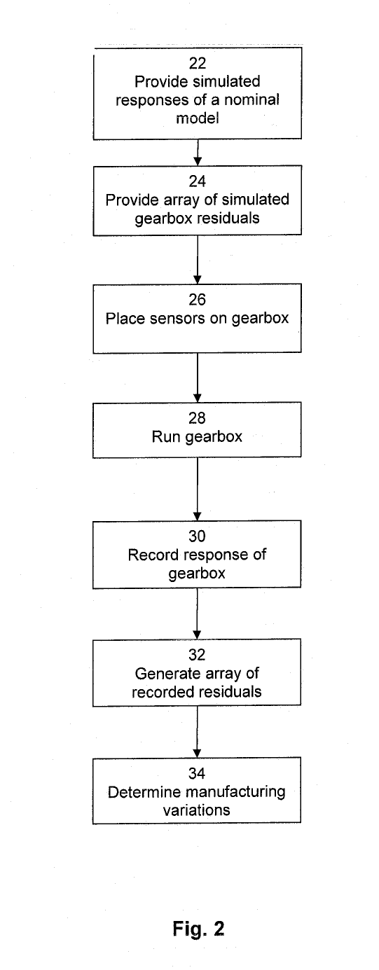

FIG. 2 shows a flow chart identifying the steps associated with determining manufacturing variations in a gearbox, drive-train or generator;

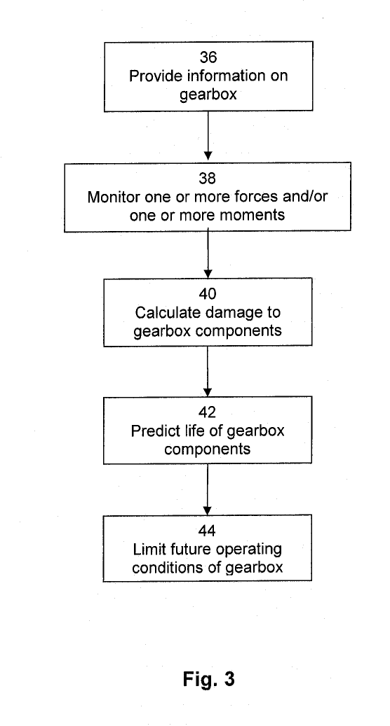

FIG. 3 shows a flow chart identifying the steps associated with operating a gearbox, drive-train or generator;

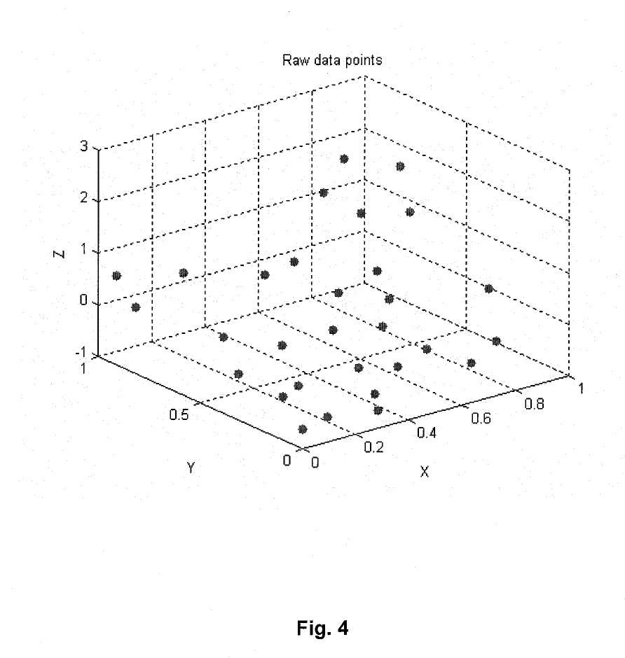

FIGS. 4, 5 and 6 show stages in the construction of a meta model; and

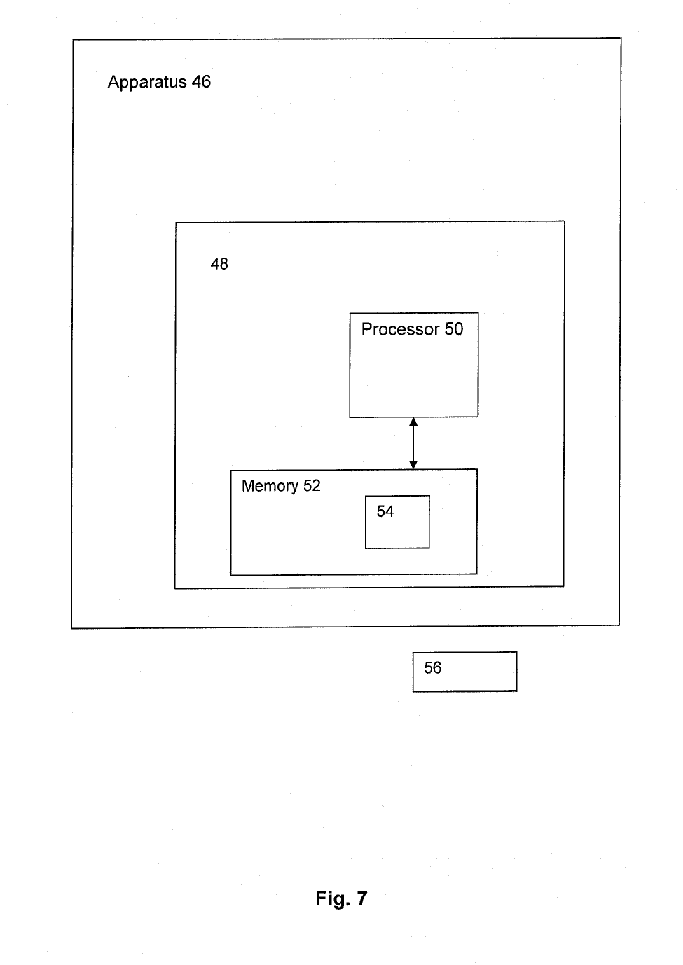

FIG. 7 illustrates a schematic diagram of an apparatus according to various embodiments of the invention.

According to one aspect the invention uses a model-based approach to determine the positions of sensors in or on a gearbox, drive-train or generator of a gear operated machine such as a wind turbine. The sensors may be end-of-line test sensors or condition monitoring sensors.

End-of-line test sensors include those sensors placed in or on a gearbox and used immediately following gearbox or drive-train manufacture. The end-of-line test sensors may be used to determine residuals and unique gearbox models as explained in detail below.

Condition monitoring sensors include those sensors placed in or on a gearbox or drive-train in order to monitor the forces and moments acting on the gearbox or drive-train during its operational life. Condition monitoring sensors may be used to predict the damage to components within a gearbox or drive-train so as to predict their life.

Sensors are positioned such that they extract an optimal amount of information about the individual components of the gearbox.

FIG. 1 shows the steps in a method for determining the location sites for end-of-line test sensors.

A nominal model of a generic gearbox is generated 10. The term “nominal model” encompasses mathematical models of a nominal gearbox design. A nominal model may typically be created using the precise dimensions of a gearbox design incorporating no manufacturing variations e.g. using the dimensions specified in the design drawings without any deviations which may be present in a manufactured and assembled gearbox. A nominal model may also be generated using the mean, median or modal dimensions. Nominal models may also include models whose dimensions are substantially similar to the precise dimensions mentioned above.

The term “manufacturing variations” includes variations from the precise specified dimensions of components of a gearbox inherently introduced during machining. The term “manufacturing variations” may also include assembly variations which comprise divergences from the precise dimensions of a gearbox design that may be introduced during construction. The term “manufacturing variations” may also include variations in clearances between gearbox components or within gearbox components.

Manufacturing variations are commonly expressed as a tolerance which is stated on engineering drawings. The magnitude of the tolerances may be decided upon based on knowledge of variations in the manufacturing and assembly processes. The magnitude of the tolerances may also be decided upon based on mathematical or statistical models of the manufacturing process. The tolerance range may be defined by absolute upper and lower limits on possible errors, or may represent some statistical variation e.g. +/−1 standard deviation of error.

The nominal model is a mathematical model that may include the following components and operating constraints:
Shafts;
Helical, spur, planetary, bevel, hypoid and worm gears (including gear microgeometry, gear tooth bending stiffness and mesh contact stiffness);
Bearings (including non-linear bearing stiffness, clearance, preloads, contacts of rolling elements with raceways and centrifugal effects);
Clearances in gearbox assembly;
Gearbox housing;
Clutches and synchronisers and their effect of defining power-flows in a gearbox
Brakes
Gravity; and/or
Operating loads consisting of forces and moments.

The nominal model may be generated using RomaxDesigner. This software is supplied by Romax Technology Ltd., Nottingham, England. RomaxDesigner may be used to model a gearbox including (but not limited to) the components and operating constraints listed above. The software is capable of analysing the gearbox model using a finite element technique whereby mass and stiffness matrices are constructed to represent the gearbox. Each node in the finite element model may have 6 degrees-of-freedom, meaning that forces and moments may be defined and measured in and about the X, Y and Z axes. Some aspects to the nominal model may be represented using analytical equations which are analysed either simultaneously or separately to the finite element aspects to the model. Some aspects to the model may be based on empirical data, e.g. the stiffness of a gear mesh measured from physical test data or from mathematical simulations.

The nominal model may simulate behaviour due to static loads or due to transient dynamic loads.

The Newton-Raphson method may be used to calculate the deflections of each node in the finite element model caused by forces and moments acting on any node or combinations of nodes in the model, taking into account non linear bearing stiffness and the non-linear effects of clearances. Forces and moments acting on each gearbox component may then be calculated. The internal structures of gearbox components such as bearings may then be modelled in detail using the same finite element technique. All elements in the model may be coupled, meaning the deflections and loads on the entire model may be solved simultaneously.

The vibrational properties of the gearbox may be predicted using the RomaxDesigner software. The spatial model of the gearbox, represented by mass and stiffness matrices, is converted from spatial coordinates to modal coordinates in the RomaxDesigner software by multiplying the mass and stiffness matrices by the eigenvectors to give modal mass and modal stiffness matrices. This modal model can then be excited, for example by one or more harmonics of the transmission error for one or more gear meshes in the model and/or by any other force or moment excitation defined at any node in the gearbox model. If a transmission error excitation is used, the transmission error may be converted into a force excitation by multiplying the transmission error by the gear mesh stiffness. Alternatively, the excitation may correspond to an excitation which is known to occur during operation of the gearbox. Alternatively, the excitation may correspond to a fault in the gearbox, e.g. a fault in a gear or bearing which excites the system at a known frequency relative to the rotational speed of the gearbox components.

The harmonic response is a force, displacement, velocity or acceleration caused by an excitation. The harmonic response at any point in the gearbox model can be represented by the response observed at the same frequency as the excitation frequency, or at multiples thereof. The harmonic response may be evaluated over a range of excitation frequencies. If the excitation is the transmission error of a gear mesh then the range of excitation frequencies corresponds to a range gearbox input speeds.

The harmonic response at any point on the gearbox or gearbox housing can be predicted using the RomaxDesigner model.

Results obtained using a fully-detailed model of the type described above have demonstrated very close correlation with test results.

The nominal model can be used to calculate a range of manufacturing variation results which may include:
Deflections or deformations of any part of the system due to operating load;
Gear mesh misalignments;
Tooth face contact patterns and load distribution;
Gear bending stresses;
Gear contact stresses;
Remaining fatigue life (e.g. number of cycles to failure) for gear contact and gear bending stress (calculated from e.g. empirical S-N curves);
Remaining bearing life (calculated from e.g. empirical data); and/or
Transmission error (calculated for e.g. a single gear mesh or a planetary gear set).

Typically, existing solutions have used simple signal-based models.

The nominal model is used, in conjunction with other models incorporating manufacturing variations, to determine the optimum end-of-line test sensor positions for end-of-line testing and for in-service vibration monitoring. The optimum end-of-line test sensor positions in each of these cases are not necessarily the same. The end-of-line test sensors may be placed on the gearbox components, the gearbox housing or any of the associated components of a gear operated machine. The end-of-line test sensors may be capable of measuring acceleration, velocity or displacement (by direct measurement or integration). The end-of-line test sensors may be capable of sensing e.g. sound pressure, sound power, sound intensity or temperature.

The nominal model is analysed and a first set of simulated responses are calculated 12. Responses, whether simulated or recorded, include all values that may be detected by sensors of various types placed at one or more locations in or on the gearbox.

The one or more locations of the end-of-line test sensors in respect of which the first set of simulated responses is calculated may be anywhere in or on the modelled gearbox. The nominal model is capable of calculating simulated responses at locations of the user's choosing. In certain embodiments the first set of simulated responses may be calculated at locations nominally spaced, which cover the entire gearbox.

The simulated responses calculated during execution of the nominal model may include harmonic responses at various locations in or on the modelled gearbox. The calculated simulated responses may alternatively relate to the torque acting on various components of a modelled gearbox, or the temperature at various locations in or on a modelled gearbox.

A Fourier transform of a time-domain signal (such as an FFT or DFT of a signal) may also provide a suitable response. Various embodiments of the invention also cover the use of models which can calculate this response.

The nominal model simulates a number of possible location sites for end-of-line test sensors. A first set of simulated responses is then calculated at each of these locations.

In one embodiment one or more of the simulated responses may be calculated when the model of the gearbox is executed at one or more operating loads. In another embodiment one or more of the simulated responses may be calculated when the model of the gearbox is executed at one or more operating speeds.

The first set of simulated responses, calculated using the nominal model, represent the responses that would be recorded from a gearbox manufactured to precise design dimensions and incorporating no manufacturing variations.

In certain embodiments of the invention at least 5, at least 10, at least 20, at least 40, at least 60, at least 80, at least 100 or more than 100 possible condition monitoring sensor location sites may be simulated.

Manufacturing variations are then introduced into the nominal model 14. A range of manufacturing variations may be simulated using the model as detailed above. These manufacturing variations, which may be selected from the list provided above, are introduced to components of the gearbox that are relevant to gearbox life and operation.

A second set of simulated responses are calculated for the modelled gearbox which incorporate the range of introduced manufacturing variations 16. The second set of simulated responses may advantageously correspond to the possible location sites, operating loads and operating speeds used when generating the first set of simulated responses. This permits direct comparison of the two sets of simulated responses.

An array of residuals is generated based on differences between the first and second set of responses 18.

As used herein, the term “residual” includes a numerical value representing a difference between a simulated response calculated using a nominal model of a gearbox and a response, either calculated on a modelled gearbox or recorded on a physical gearbox, incorporating manufacturing variations.

The residuals may for example be calculated from the differences between the response of the nominal design and the design incorporating the range of manufacturing variations. Each residual may correspond to a different sensor position. Each residual may also correspond to a different operating load and may be calculated over a different range of excitation frequencies (i.e. a different range of input speeds to the model).

The various possible sensor location sites, operating loads and operating speeds mentioned above are chosen to maximise the ability of the method to discriminate between different manufacturing tolerances. Each residual may also be calculated using a different metric e.g. the root mean square difference between corresponding simulated responses from the first and second set of simulated responses; the cross correlation coefficient of corresponding simulated responses from the first and second set of simulated responses; the difference in the root mean square of the amplitude of corresponding simulated responses from the first and second set of simulated responses; and the sum of the absolute differences between corresponding simulated responses from the first and second set of simulated responses.

Each residual may correspond to any of these metrics evaluated over one or more subsets of the original responses, wherein a subset may correspond to a range of input speeds.

Typically residuals have previously been generated from state variables of a system. For example, residual generation has been used in motor vehicle On Board Detection (OBD) systems to detect faults in an engine air-flow system. In such examples the state variables may be air mass flow; manifold pressure; manifold temperature and/or throttle position. However, in end of line testing and condition monitoring applications there is not necessarily a correlation between the state variables and the manufacturing variations, condition or sustained damage of a gearbox.

Various embodiments of the invention extend the state variable technique to generate residuals from metrics obtained from the sensors placed on the gearbox housing or components. Additionally, in certain aspects the invention advantageously uses residuals not to identify faults, but to detect manufacturing variations, dimensions and clearances within the system.

One or more of the simulated sites are selected as respective location sites for the end-of-line test sensors 20.

The optimum sensor positions are those which permit discrimination between different types of manufacturing variation using only a limited number of sensors. The location sites for the end-of-line test sensors are selected such that the one or more of the residuals in the array displays a unique signature for one or more manufacturing variations.

If a unique signature of residuals corresponding to a particular manufacturing variation is detected using a sensor or sensors placed in or on a manufactured gearbox the presence of that manufacturing variation within the gearbox may be inferred.

The minimum number of end-of-line test sensors required to detect the range of manufacturing variations, clearances or faults of interest is calculated using an algorithm that selects sensor location sites to improve fault detectability and isolability. The simplest algorithm to do this is to use an exhaustive search technique. Firstly, pairs of sensors are considered and checked to determine whether they provide detectability and isolability for a type of manufacturing variation. If no pairs of sensors provide detectability and isolability, then sets of three sensors are considered. The number of sensors in the set may be increased and the checking process repeated until a suitable sensor set is found.

The table below shows an example of an array of residuals in which each combination of manufacturing variations has a unique signature.

| | | Residuals | | | | | | | |
|---|---|---|---|---|---|---|---|---|---|
| | | 1 | 2 | 3 | 4 | 5 | 6 | 7 | 8 |
| Manufacturing | Variation A = 0%, | 10.2 | 12.5 | 40.7 | 0.2 | 0.3 | 20.5 | 21.7 | 0.1 |
| Variations | Variation B = 0% | | | | | | | | |
| | Variation A = 0%, | 10.5 | 12.1 | 20.5 | 1.1 | 0.1 | 21.8 | 19.4 | 0.2 |
| | Variation B = +50% | | | | | | | | |
| | Variation A = 0%, | 9.8 | 10.6 | 41.0 | 22.2 | 0.5 | 22.1 | 20.0 | 0.1 |
| | Variation B = −50% | | | | | | | | |
| | Variation A = 0%, | 40.5 | 12.4 | 41.6 | 1.0 | 0.7 | 19.8 | 23.1 | 0.4 |
| | Variation B = +100% | | | | | | | | |

Each row of the table represents a different manufacturing variation introduced into the nominal model. The residuals numbered 1 to 8 may correspond to different condition monitoring sensor location sites and/or different gearbox operating loads and/or different ranges of gearbox operating speeds.

A threshold may be placed on residuals to convert the numbers into binary form (i.e. 1 if the threshold is exceeded, 0 otherwise). The threshold may be different for each residual in the table. Also, multiple thresholds may be placed on each number and the numbers converted into a numeral system with the corresponding base. The following table shows an example of residuals in binary form:

| | | Residuals | | | | | | | |
|---|---|---|---|---|---|---|---|---|---|
| | | 1 | 2 | 3 | 4 | 5 | 6 | 7 | 8 |
| Manufacturing | Variation A = 0%, | 0 | 1 | 1 | 0 | 0 | 0 | 1 | 0 |
| Variations | Variation B = 0% | | | | | | | | |
| | Variation A = 0%, | 0 | 1 | 0 | 0 | 0 | 1 | 0 | 0 |
| | Variation B = +50% | | | | | | | | |
| | Variation A = 0%, | 0 | 0 | 1 | 1 | 0 | 1 | 0 | 0 |
| | Variation B = −50% | | | | | | | | |
| | Variation A = 0%, | 1 | 1 | 1 | 0 | 0 | 0 | 1 | 1 |
| | Variation B = +100% | | | | | | | | |

In the above table a ‘0’ represents a residual which is below a threshold value and a ‘1’ represents a residual which is above a threshold value.

The quantization of the residuals generates a table of ones and zeros which allows easier identification of the unique signature for each type of manufacturing variation.

The method of various embodiments of the invention may include the additional step of placing one or more end-of-line test sensors in or on a gearbox at locations corresponding to the selected locations. The sensors may be capable of detecting acceleration, velocity and/or displacement. The sensors may be inertial or piezoelectric sensors. Alternatively the sensors may include other sensors capable of sensing e.g. sound pressure, sound power, sound intensity or temperature.

According to various embodiments of the invention in another aspect a method of determining manufacturing variations of components within a gearbox is provided. FIG. 2 shows the steps in a method for determining such manufacturing variations.

Simulated responses from a nominal model of a gearbox, such as those detailed above, are provided 22. The simulated responses correspond to the responses expected from a gearbox manufactured to a precise design and incorporating no manufacturing variations.

An array of simulated residuals corresponding to various locations in or on a modelled gearbox is provided 24. The array of simulated residuals represents a set of unique signatures which correspond to a range of manufacturing variations that may occur in a gearbox. The process of attaining the simulated residuals is detailed above.

The simulated residuals may be calculated from simulated responses when the model of the gearbox is executed at one or more simulated operating loads. The simulated residuals may also be calculated from simulated responses when the model of the gearbox is executed at one or more simulated operating speeds.

One or more end-of-line test sensors are placed in or on a gearbox in locations which correspond to those used in the generation of the simulated residuals 26. The end-of-line test sensors may be capable of detecting acceleration, velocity and/or displacement. The end-of-line test sensors may be inertial or piezoelectric sensors. Alternatively, the end-of-line test sensors may be capable of sensing other forces acting on the gearbox e.g. sound pressure, sound power, sound intensity or temperature.

The gearbox is then run 28. Running the gearbox may include running the gearbox at one or more operating speeds and/or one or more operating loads. The one or more operating speeds and operating loads may advantageously correspond to the simulated operating speeds and operating loads to permit direct comparison of recorded and simulated responses.

The responses of the actual manufactured gearbox are detected and recorded using the end-of-line test sensors placed on the gearbox 30. The recorded responses are indicative of the manufacturing variations present in the manufactured gearbox.

An array of recorded residuals is then generated 32. The recorded residuals are calculated based on differences between the simulated responses of the nominal model and the recorded responses of the manufactured gearbox, detected using the end-of-line test sensors.

The manufacturing variations of the manufactured gearbox are determined from a comparison of the array of recorded residuals with the array of simulated residuals 34. If a combination of residuals is calculated that matches or is close to the unique signature of a particular manufacturing variation, the presence of that manufacturing variation in the gearbox can be inferred.

For example, a residual signature may be recorded and associated with a given manufacturing variation, say 0% of variation A and +50% of variation B. The residual signature may take the form:
[0.4 13.2 20.1 1.0 0.1 21.7 20.0 0.3]
   as shown in the table above.

In this example, these values correspond to the correlation coefficient calculated by comparing the harmonic response of a gearbox with the harmonic response of the nominal model, the measurements being made at eight different sensor locations. Thresholds may be applied to the residuals to convert them into binary form:
[0 1 1 0 0 1 1 0]

A recorded signature such as that seen above at the eight sensor locations would indicate that the gearbox is experiencing 0% of Variation A and +50% of Variation B.

In one embodiment of the invention the determined manufacturing variations are associated with percentage values representing confidence in the accuracy of the determined manufacturing variations.

The method shown in FIG. 2 may be incorporated into an end of line test of gearboxes. Every gearbox manufactured may be tested as it comes off the production line so as to determine the manufacturing variations unique to that particular gearbox.

Following an end of line test, a unique model may be generated for each gearbox that leaves a production line. Each unique model is generated using the dimensions and clearances inferred from the end of line test and may remain related to the corresponding gearbox throughout its operational life. This can be achieved via a local or remote computer.

The unique model can be used to calculate the forces and moments that may act on a gearbox at any location or particular locations in or on the gearbox when operating under a given load and at a given speed. This in turn permits the calculation of the predicted damage sustained by each component when the gearbox is in operation based on the outputs of the condition monitoring sensors in or on the gearbox.

According to various embodiments of the invention in another aspect a method of operating a gear box is provided. FIG. 3 shows the steps in a method for operating a gearbox using a model-based diagnosis approach.

Information on a particular gearbox may be provided 36. The information includes information relating to one or more manufacturing variations in the dimensions and clearances of components of a gearbox. The information on the gearbox may include a fully coupled model with six degrees of freedom. The model may also be unique to the gearbox. The generation of such a unique model is described in detail above.

Forces and moments acting on the gearbox are monitored over time 38. Forces and moments acting on the gearbox are continuously monitored during operation. These measurements may be taken at a regular sampling frequency of e.g. 50 Hz. In various embodiments of the invention, step 38 may include monitoring one or more forces and/or one or moments over time.

Monitoring one or more forces and/or one or more moments may include monitoring outputs of one or more condition monitoring sensors placed in or on the gearbox at predetermined locations, the predetermined locations calculated based on the provided information on the gearbox. In one embodiment the predetermined locations are calculated using residuals based on a nominal model of the gearbox, and a model of the gearbox incorporating manufacturing variations.

The condition monitoring sensors may be capable of detecting acceleration, velocity and displacement. The condition monitoring sensors may be inertial or piezoelectric sensors. Alternatively, the sensors may be capable of sensing other forces acting on the gearbox e.g. sound pressure, sound power, sound intensity or temperature.

The damage caused to each component by the one or more forces and/or one or more moments measured in each sample of data is calculated 40. To do this, the fully coupled system model described above is used to calculate the system deflections and component loads. The contact between gear teeth is modelled using finite elements taking into account the tooth bending stiffness and gear mesh contact stiffness. These stiffnesses can be calculated or based on empirical data and are taken into account in the static deflection analysis of the full model. The tooth face load distribution, tooth contact stress or bending stress may be calculated for each gear mesh. These values may then be compared with empirical data or empirical methods used to calculate the operating contact stress, e.g. according to methods given in ISO 6336-2. The tooth bending stress may be calculated using finite element models or may be calculated using empirical methods, e.g. methods in ISO 6336-3. S-N curves for gear contact failure and gear bending failure may be employed and may be based on mathematical simulations or may be based on empirical data, e.g. data provided in ISO 6336.

The calculation of bearing damage can be performed using the RomaxDesigner software. This calculation takes into account factors such as bearing internal geometry, stiffness and deformation of bearing components, contact between bearing components and considers the bearing loads and stiffness. The bearing life may be calculated from these factors using mathematical simulations or empirical data, e.g. data provided in ISO 281.

The output is a value for the L10 life, as defined in ISO 281.

From this point on, ‘percentage damage’ is defined as the proportion of the total life of a component which has been consumed. Component lives are statistical in nature, so 100% damage may correspond to a probability of failure for the component.

Using the calculated cumulative damage a prediction of the remaining life of one or more components of the gearbox can be made 42. A prediction of the cumulative damage on each component is continuously updated, thus allowing the remaining life of each component to be predicted using empirical data e.g. S-N curves and bearing life data available from ISO standards. The probability of failure for each component can then be calculated in a given period of time e.g. the period of time leading up to the next scheduled maintenance.

As used herein the term “life” when applied to the components of a gearbox may represent the time to complete failure of the component or the time to degradation of component performance to a predetermined level, e.g. a lowest acceptable level for continued operation of the gearbox or machine in which the gearbox is installed. The term “life” may also encompass the time up to which the probability of failure exceeds a certain level.

The predicted life of the one or more components of the gearbox may be associated with a percentage value representing the probability that the one or more components will fail within a predetermined time. The probability of failure of a gearbox system or any individual gear or bearing therein may be calculated using the RomaxDesigner software described above. In this case, the probability of failure corresponds to either a given load applied for a given duration or a collection of such loads.

Following the prediction of the remaining life of one or more components of the gearbox the operation of the gearbox may be limited in order to achieve a desired life of the gearbox 44.

The operation of the gearbox can be limited to exist within a particular envelope of operating conditions. For instance if the probability of failure before a scheduled maintenance is considered by the operator to be too high, the operation of the gearbox can be adjusted such that the probability of gearbox failure is reduced and the predicted life of the gearbox is extended. Alternatively, it may be discovered that the gearbox is running within an unnecessarily low operation envelope. In this case the operator may wish to increase the operating load and speed of the gearbox such that output from the gearbox is maximised before a scheduled maintenance event. This enables the gearbox operator to manage the operation of the gearbox to reduce unscheduled maintenance requirements and optimally manage the operation of the gearbox.

It is possible that the provided gearbox information cannot be analysed at as high a frequency as the data is sampled. For example, the model analysis required to predict the damage due to each sample of data may take 1 second, but the data may be sampled at 50 Hz. In this case an approximation (a meta-model) can be employed so that the damages are predicted more quickly.

The meta-model is constructed in three stages:
1) a number of data samples are obtained from a gearbox model prior to the start of gearbox operation;
2) an underlying trend is determined using response surface methodology (RSM);
3) Gaussian deviations from this trend are introduced using a Gaussian kernel centred on each sample point.

The metamodel may be constructed using only steps 1) and 2) above.

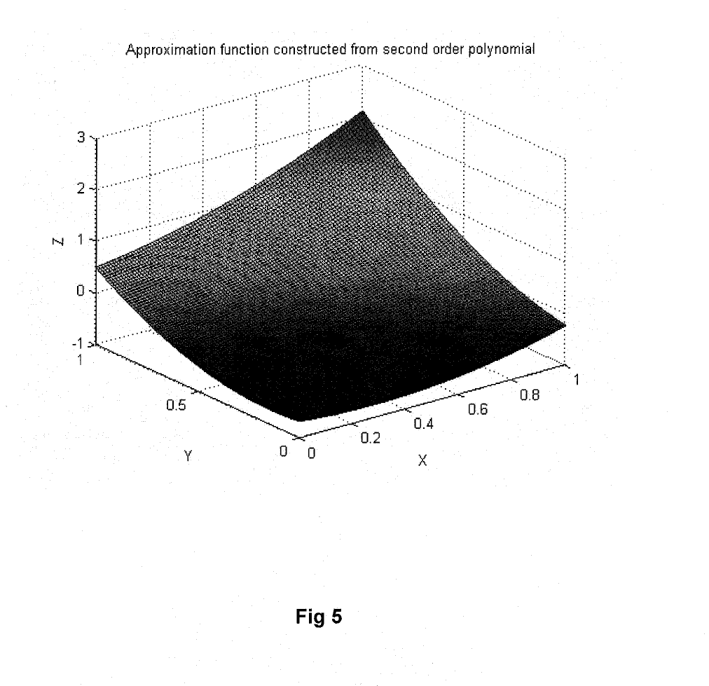

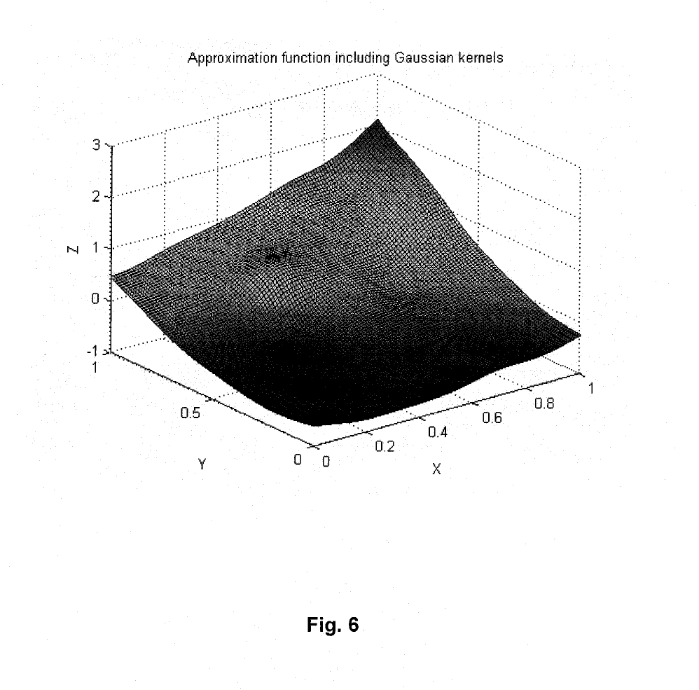

FIGS. 4 to 6 show the three stages listed above applied to a two-variable problem. FIG. 4 shows the plotted raw data points. FIG. 5 shows the approximation function constructed from a second order polynomial. FIG. 6 shows the approximation function including Gaussian kernels.

The variables in the metamodel can be one or more of the following loads which may be defined anywhere in the gearbox model, drivetrain or generator: force in the x-direction (Fₓ); force in the y-direction (F_{y}); force in the z-direction (F_{z}); moment about the x-axis (Mₓ); moment about the y-axis (M_{y}); moment about the z-axis (M_{z}). Alternatively, the variables may include displacements in any of the x, y and z directions or rotations about any of the x, y, and z axes or temperature.

The metamodel is constructed from data samples each of which corresponds to a different combination of any of the variables listed above. The accuracy of the meta model can depend on the method used to determine the variables used to generate each data sample. A sampling regime in which the sample points are randomly determined is possible but is not ideal because it can result in some data samples having similar variables which may result in the metamodel being inaccurate. Spacing the data samples uniformly in the design space represented by the metamodel variables is preferred.

Uniform sampling of data in the metamodel variables design space is achieved by optimising the sampling strategy using a genetic algorithm. One method is to maximise the minimum distance between any two neighbouring sample points. Many other suitable sampling strategies exist in literature including minimising the maximum distance between any two neighbouring sample points; L2 optimality; latin hypercube sampling.

The process of identifying the underlying trend using Response Surface Methodology (RSM) consists of fitting a polynomial to the sample data using linear regression. The polynomial can be of any order and may include some or all of the possible terms. The number of variables in the polynomial is equal to the number of variables in the metamodel. A transformation can be applied to the sampled data before fitting the polynomial in order to decrease the ‘model bias’ which can arise due to the assumption that the data follows a polynomial trend. For example, if the behaviour of the response is observed to follow a trend similar to an exponential, then a polynomial can be fitted to the natural log of the variables in order to improve the metamodel accuracy.

The Gaussian deviations (step 3 above) may be represented by Gaussian functions with a number of dimensions equal to the number of variables in the metamodel. The deviations are not required to be Gaussian functions and may be represented by another mathematical function. The amplitude of each deviation may be equal to or related to the difference between the output of the polynomial model and the response level of the data sample.

A unique meta-model is constructed for each component in the gearbox (i.e. for each gear and bearing) to relate the measured variables with the resulting tooth face load distribution factor, KH_{β}, (for gears, as defined in ISO 6336) and load zone factor (for bearings, as defined in ISO 281). Any number of forces and moments acting at any point on the gearbox, drive train or generator may be related to these factors by the metamodels. The load zone factors and KH_{β} values may then be used to calculate a corresponding amount of damage caused to each component. The metamodels may alternatively relate the measured variables with component stresses, component lives or percentage damages.

In one embodiment monitoring forces and moments acting on the gearbox also includes using outputs of an existing CMS, which may be installed in or on the gearbox or surrounding machinery. The existing CMS may include vibration analysis; acoustic monitoring; analysis of oil quality; temperature monitoring or electrical generator monitoring. The output of other CMSs may be used in parallel with the data of the model-based diagnosis approach.

If an existing CMS is to be used in conjunction with the model-based diagnosis approach, the output of each system should be preferably expressed as a probability. This probability may be the probability that the CMS is correctly predicting a certain level of damage in a given component at a given moment in time.

Existing CMS apparatus is reported to have some ability to measure gearbox life. For example, if analysis of gearbox lubricant shows degradation of oil quality or an increase in particles in the lubricant then this can indicate impending gearbox failure. Previous data on the failure of similar gearboxes may be used to predict remaining gearbox based on measured quantities.

Consider, for example, a vibration CMS. Signals from accelerometers are commonly studied to obtain information about the condition of a system, e.g. by studying metrics such as vibration amplitudes, spectral kurtosis, using techniques such as envelope analysis, Fourier transforms or wavelet transforms to extract information from recorded vibration data, If some metric calculated from recorded vibration data changes over time then this can indicate impending gearbox failure. Previous data on the failure of similar gearboxes may be used to predict remaining gearbox based on measured quantities or calculated metrics.

If an existing CMS is to be used in conjunction with the model-based diagnosis approach, the output of each system should be preferably expressed as a probability. This probability may be the probability that the CMS is correctly predicting a certain level of damage in a given component at a given moment in time. Expressing the CMS output in this way enables the CMS result to be combined with the percentage value representing the predicted life calculated using the model-based diagnosis approach.

If a vibration analysis CMS is employed, the sensor positions are determined using the same approach as in the method of determining condition monitoring sensor positions described above. However, residuals are now generated to give a unique signature for a range of levels of each type of component damage e.g. 75% contact damage on gear no. 1 will have a unique signature of residuals. A percentage confidence is again associated with each prediction, which may be combined with the probability calculated using the model-based diagnosis approach. Thus, the percentage value representing the probability that one or more components will fail may incorporate information from an existing CMS.

The ultimate result from the combined model-based diagnosis/CMS approach is the probability of failure of each component in a given period of time. From this, the probability of failure for the entire gearbox in a given period of time is calculated. These probabilities of failure incorporate a number of factors: the percentage confidence that the unique model generated in the end of line test is an accurate representation of the actual gearbox (calculated from the similarity between the residuals calculated from the measured responses and the unique signatures of residuals representing each combination of manufacturing variations); the continuously updated in-service probability of failure in a given period of time, calculated from the unique model (or meta-model) using the measured forces and moments acting on the gearbox; the probability of failure occurring in a given time period indicated by the CMS and the percentage confidence that the CMS prediction is accurate.

If the probability of failure in a given time period is insufficient for a user or operator's demands, a new operating regime is recommended by the model-based diagnosis system in order to provide the required probability of failure. For example, the new operating regime could be to operate the gearbox at a lower capacity, therefore reducing the forces and moments acting on the gearbox.

FIG. 7 illustrates a schematic diagram of an apparatus 46 according to various embodiments of the present invention. The apparatus 46 includes means 48 for performing the steps illustrated in FIGS. 1, 2 and 3.

In various embodiments, means 48 includes a processor 50 and a memory 52. The processor 50 (e.g. a microprocessor) is configured to read from and write to the memory 52. The processor 50 may also comprise an output interface via which data and/or commands are output by the processor 50 and an input interface via which data and/or commands are input to the processor 50.

The memory 52 stores a computer program 54 comprising computer program instructions that control the operation of the apparatus 46 when loaded into the processor 50. The computer program instructions 54 provide the logic and routines that enables the apparatus 46 to perform at least some of steps of the methods illustrated in FIGS. 1 to 3. The processor 50 by reading the memory 52 is able to load and execute the computer program 54.

The computer program may arrive at the apparatus 46 via any suitable delivery mechanism 56. The delivery mechanism 56 may be, for example, a computer-readable storage medium, a computer program product, a memory device, a record medium such as a Blue-ray disk, CD-ROM or DVD, an article of manufacture that tangibly embodies the computer program 54. The delivery mechanism may be a signal configured to reliably transfer the computer program 54. The apparatus 46 may propagate or transmit the computer program 54 as a computer data signal.

Although the memory 52 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The steps illustrated in the FIGS. 1 to 3 may represent steps in a method and/or sections of code in the computer program 54. The illustration of a particular order to the steps does not necessarily imply that there is a required or preferred order for the steps and the order and arrangement of the steps may be varied. Furthermore, it may be possible for some steps to be omitted.

Other embodiments are intentionally within the scope of the appended claims.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method for operating a gearbox, drive-train and/or generator, the method comprising:
a) monitoring over time one or more forces and/or one or more moments acting on the gearbox, drive-train and/or generator;
b) calculating damage caused to each of the one or more components of the gearbox, drive-train and/or generator based on the one or more forces and/or one or more moments acting on the gearbox, drive-train and/or generator;
c) predicting the life of the one or more components within the gearbox, drive-train and/or generator based on the calculated damage to the one or more components and predetermined or predicted future operating conditions of the gearbox, drive-train and/or generator.

2. The method according to claim 1 including subsequent to step c), limiting the future operating conditions of the gearbox, drive-train and/or generator to achieve a desired life of the one or more components within the gearbox, drive-train and/or generator.

3. The method according to claim 1 including an initial step of providing information on the gearbox, drive-train and/or generator.

4. The method according to claim 3 wherein the provided information includes a nominal model of gearbox, drive-train and/or generator.

5. The method according to claim 4 wherein the model is unique to the gearbox, drive-train and/or generator and includes information on one or more manufacturing variations of one or more components of the gearbox, drive-train and/or generator.

6. The method according to claim 5 wherein the model includes a fully coupled finite element model comprising nodes with six degrees of freedom unique to the gearbox, drive-train and/or generator.

7. The method according to claim 3 wherein the information on the gearbox, drive-train and/or generator includes one or more meta-models.

8. The method according to claim 3 wherein monitoring one or more forces and/or one or more moments acting on the gearbox, drive-train and/or generator includes monitoring outputs of one or more condition monitoring sensors placed in or on the gearbox, drive-train and/or generator at predetermined locations calculated using residuals based on a nominal model of the gearbox, drive-train and/or generator, and a model of the gearbox, drive-train and/or generator incorporating manufacturing variations.

9. (canceled)

10. The method according to claim 1 wherein monitoring forces and moments acting on the gearbox, drive-train and/or generator includes using outputs from an existing condition monitoring system installed in or on the gearbox, drive-train and/or generator.

11. (canceled)

12. The method according to claim 2 wherein the predicted life of the one or more components is associated with a percentage value representing the probability that the one or more components will fail within a predetermined time.

13. The method according to claim 12 wherein the percentage value incorporates information from the an existing condition monitoring system installed in or on the gearbox, drive-train and/or generator.

14. The method according to claim 2 wherein the gearbox, drive-train and/or generator forms part of a wind turbine and wherein the step of limiting future operating conditions includes changing the pitch on one or more rotor blades of the wind turbine applying a brake, deploying retarding features on the wind turbine blades and/or changing the orientation of the wind turbine nacelle.

15. An apparatus for operating a gearbox, drive-train and/or generator, the apparatus comprising
a) means for monitoring over time one or more forces and/or one or more moments acting on the gearbox, drive-train and/or generator;
b) means for calculating damage caused to each of the one or more components of the gearbox, drive-train and/or generator based on the one or more forces and/or one or more moments acting on the gearbox, drive-train and/or generator;
c) means for predicting the life of the one or more components within the gearbox, drive-train and/or generator based on the calculated damage to the one or more components and predetermined or predicted future operating conditions of the gearbox, drive-train and/or generator.

16. A computer readable storage medium encoded with instructions that, when executed by a processor; perform:
a) monitoring over time one or more forces and/or one or more moments acting on the gearbox, drive-train and/or generator;
b) calculating damage caused to each of the one or more components of the gearbox, drive-train and/or generator based on the one or more forces and/or one or more moments acting on the gearbox, drive-train and/or generator;
c) predicting the life of the one or more components within the gearbox, drive-train and/or generator based on the calculated damage to the one or more components and predetermined or predicted future operating conditions of the gearbox, drive-train and/or generator.

17-43. (canceled)

44. The method according to claim 3 wherein the information on the gearbox, drive-train and/or generator includes one or more meta-models, each meta-model constructed according to the steps of:
a) obtaining a number of data samples from the gearbox, drive-train and/or generator prior to a start of operating;
b) determining an underlying trend between the data points;

45. The method according, to claim 44 wherein the one or more meta-models are specific for each of the one or more components.

46. The apparatus according to claim 15 including means for limiting the future operating conditions of the gearbox, drive-train and/or generator to achieve a desired life of the one or more components within the gearbox, drive-train and/or generator.

47. The apparatus according to claim 46 wherein the gearbox, drive-train and/or generator forms part of a wind turbine and wherein means for limiting the future operating conditions includes pitch-changing means on one or more rotor blades of the wind turbine, retarding means on the wind turbine blades and/or orientation-changing means on the wind turbine nacelle.

48. The apparatus according to claim 15 including a nominal model of the gearbox, drive-train and/or generator.

49. The apparatus according to claim 48 wherein the nominal model is a fully coupled finite element model comprising nodes with six degrees of freedom.

50. The apparatus according to claim 49 wherein the model is unique to the gearbox, drive-train and/or generator and includes information on one or more manufacturing variations of one or more components of the gearbox, drive-train and/or generator.

51. The apparatus according to claim 15 including one or more meta-models.

52. The apparatus according to claim 51 including, wherein each of the meta-models is specific for each of the one or more components and wherein each of the meta-models includes an approximation of a behavior of each component.

53. The apparatus according to claim 15 including one or more condition monitoring sensors located at predetermined locations in or on the gearbox, drive-train and/or generator calculated using residuals based on a model of the gearbox, drive-train and/or generator, and a model of the gearbox, drive-train and/or generator incorporating manufacturing variations.

54. The apparatus according to claim 15 including an existing condition monitoring system installed in or on the gearbox, drive-train and/or generator
